(19) United States
(12) Patent Application Publication
(10) Pub. No.: US 2014/0336038 A1
(43) Pub. Date: Nov. 13, 2014

(54) ZPGM Catalytic Converters (TWC application)

(71) Applicants: Zahra Nazarpoor, Camarillo, CA (US); Stephen J. Golden, Santa Barbara, CA (US)

(72) Inventors: Zahra Nazarpoor, Camarillo, CA (US); Stephen J. Golden, Santa Barbara, CA (US)

(73) Assignee: CDTi, Ventura, CA (US)

(21) Appl. No.: 13/891,631

(22) Filed: May 10, 2013

(51) Int. Cl. B01J 29/076; B01J 23/889

(52) U.S. Cl. CPC B01J 29/076; B01J 23/8892
USPC 502/65; 502/304; 502/303

(57) ABSTRACT

Compositions and methods for the preparation of ZPGM catalytic converters are disclosed. Addition of Mn to ZPGM catalytic converters from prior ZPGM catalytic may create a new ZPGM catalytic converter with greater improvement TWC conditions compared to previous types. Suitable known in the art chemical techniques, deposition methods and treatment systems may be employed in order to form the disclosed ZPGM catalyst systems. Disclosed ZPGM TWC systems in catalytic converters may be employed to decrease the pollution caused by exhaust from various sources, such as automobiles, utility plants, processing and manufacturing plants, airplanes, trains, all-terrain vehicles, boats, mining equipment, and other engine-equipped machines.

### BACKGROUND

1. Technical Field

This disclosure relates generally to catalytic converters, more particularly, to zero platinum group metals catalytic converters.

2. Background Information

Emission standards for unburned contaminants, such as hydrocarbons, carbon monoxide and nitrogen oxide, continue to become more stringent. In order to meet such standards, three-way catalysts (TWC) are used in the exhaust gas lines of internal combustion engines. These catalysts promote the oxidation of unburned hydrocarbons and carbon monoxide as well as the reduction of nitrogen oxides in the exhaust gas stream.

Common three way catalysts (TWC) may work by converting carbon monoxide, hydrocarbons and nitrogen oxides into less harmful compounds or pollutants. TWC within catalytic converters are generally fabricated using at least some platinum group metals (PGM). With the ever stricter standards for acceptable emissions, the demand on PGM continues to increase due to their efficiency in removing pollutants from exhaust. However, this demand, along with other demands for PGM, places a strain on the supply of PGM, which in turn drives up the cost of PGM and therefore catalysts and catalytic converters.

For the foregoing reasons, there is a need for improved TWC systems that do not require PGM and that may exhibit similar or better efficiency than prior art TWC catalysts.

### SUMMARY

ZPGM catalytic converters are disclosed. The ZPGM catalytic converters may oxidize toxic gases, such as carbon monoxide and hydrocarbons and reduce nitrogen oxides. ZPGM catalyst converters may include: a substrate, a washcoat, and an overcoat. Washcoat and overcoat may include at least one ZPGM catalyst, carrier material oxides and OSMs. Suitable known in the art chemical techniques, deposition methods and treatment systems may be employed in order to form the disclosed ZPGM catalytic converters.

Catalytic converters that include combinations of Cu, Ce and Mn in the washcoat or overcoat may be suitable for use as TWC catalysts. Suitable materials for use as substrates may include refractive materials, ceramic materials, metallic alloys, foams, microporous materials, zeolites, cordierites, or combinations.

Suitable carrier material oxides for the disclosed washcoat or overcoat may include one or more selected from a group including aluminum oxide (Al₂O₃) or doped aluminum oxide. The doped aluminum oxide in washcoat or overcoat may include one or more selected from a group including of lanthanum, yttrium, lanthanides and mixtures thereof. Washcoat or overcoat may include oxygen storage materials (OSM), such as cerium, zirconium, lanthanum, yttrium, lanthanides, actinides, and mixtures thereof. The washcoat may include at least one zero platinum group transition metal such as manganese. The overcoat may include copper oxide and cerium oxide. Suitable known in the art chemical techniques, deposition methods and treatment systems may be employed in order to form the disclosed ZPGM catalytic converters.

The ZPGM catalysts tested in different conditions for TWC applications show different response to aging temperature, including the improvement of NOX conversion and HC conversion after aging. In state of space velocity, the sensitivity of ZPGM catalysts shows no significant dependency of NOX T50 for fresh sample. Other tests, including sweep test comparing R-values for ZPGM catalyst, show that aging may help decrease the gap between cross point R-values of ZPGM catalysts and reference PGM catalysts. In another test, NO and CO conversion show very high conversion under isothermal oscillating condition.

Numerous other aspects, features and advantages of the present disclosure may be made apparent from the following detailed description, taken together with the drawing figures.

### BRIEF DESCRIPTION OF THE DRAWINGS

The present disclosure can be better understood by referring to the following figures. The components in the figures are not necessarily to scale, emphasis instead being placed upon illustrating the principles of the invention. In the figures, reference numerals designate corresponding parts throughout the different views.

FIG. 1 shows a catalyst system structure, according to an embodiment.

FIG. 2 illustrates substrate structures, according to an embodiment.

FIG. 3 illustrates sensitivity of ZPGM catalyst to aging temperature, according to an embodiment.

FIG. 4 shows a comparison of ZPGM system from example #1 with a standard PGM catalyst as a reference catalyst.

FIG. 5 illustrates the sensitivity of ZPGM catalyst to variation of space velocity, according to an embodiment.

FIG. 6 shows sweep test results under steady state condition for ZPGM catalyst of example #1, according to an embodiment.

FIG. 7 shows sweep test result under oscillating condition for ZPGM catalyst of example #1, according to an embodiment

FIG. 8 shows comparisons of R-values for sweep test under steady state, according to an embodiment.

FIG. 9 shows results for oscillating isothermal test at 550° C., according to an embodiment.

### DETAILED DESCRIPTION

The present disclosure is here described in detail with reference to embodiments illustrated in the drawings, which form a part hereof. In the drawings, which are not necessarily to scale or to proportion, similar symbols typically identify similar components, unless context dictates otherwise. Other embodiments may be used and/or other changes may be made without departing from the spirit or scope of the present disclosure. The illustrative embodiments described in the detailed description are not meant to be limiting of the subject matter presented herein.

### Definitions

As used here, the following terms have the following definitions:

“Complexing agent” refers to a substance capable of promoting the formation of complex compounds.

“Exhaust” refers to the discharge of gases, vapor, and fumes including hydrocarbons, nitrogen oxide, and/or carbon monoxide.

“Impregnation” refers to the process of totally saturating a solid layer with a liquid compound.

“Wash-coat” refers to at least one coating including at least one oxide solid that may be deposited on a substrate.

“Over-coat” refers to at least one coating including one or more oxide solids or metals that may be deposited on at least one wash-coat or impregnation layer.

“R Value” refers to the number obtained by dividing the reducing potential by the oxidizing potential.

“Rich Exhaust” refers to exhaust with an R value above 1.

“Lean Exhaust” refers to exhaust with an R value below 1.

“Conversion” refers to the chemical alteration of at least one material into one or more other materials.

“T50” refers to the temperature at which 50% of a material is converted.

“T90” refers to the temperature at which 90% of a material is converted.

“Three Way Catalyst (TWC)” refers to a catalyst suitable for use in converting at least hydrocarbons, nitrogen oxide, and carbon monoxide.

“Zero Platinum Group (ZPGM) Catalyst” refers to a catalyst completely or substantially free of platinum group metals.

“Platinum Group Metals (PGMs)” refers to platinum, palladium, ruthenium, iridium, osmium, and rhodium.

### Description

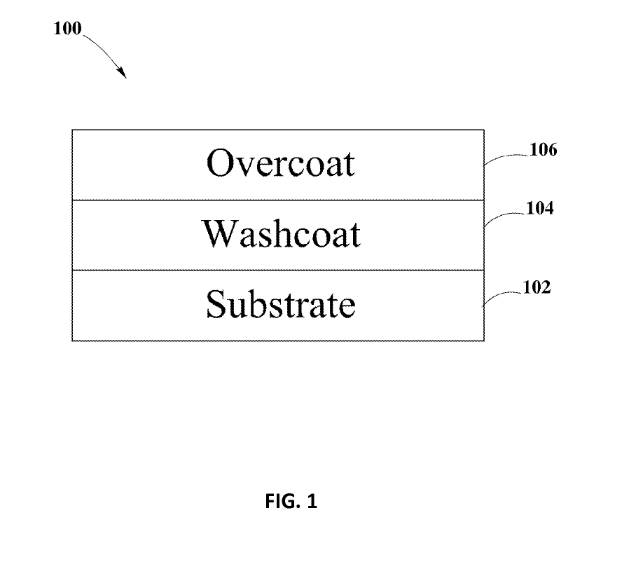

FIG. 1 shows a ZPGM TWC catalyst system 100, which may include a substrate 102, a washcoat 104, and an overcoat 106. Both manganese (Mn) and copper (Cu) are provided as catalysts, with copper in overcoat 106 and manganese preferably in washcoat 104. The manganese may also be provided in overcoat 106, but when in overcoat 106, stabilization may be needed for greatest effectiveness. Other components known to one of ordinary skill in the art may be included. For example, an OSM may be employed, but the catalysts of the present disclosure are found to function well as oxidation/reduction catalysts without an OSM.

The ZPGM TWC catalyst system 100 may also include one or more mixed metal oxide catalysts, one or more zeolite catalysts, one or more OSM's, and one or more carrier material oxides, such as alumina, in overcoat 106 and/or the washcoat 104.

In the preparation of a ZPGM TWC catalyst system 100 including a substrate 102, a washcoat 104 and an overcoat 106, washcoat 104 may be deposited in two different ways. First, depositing all desired components including ZPGM in one step as washcoat 104. Or second, depositing components without a catalyst, then separately depositing at least one impregnation component and heating (this separate deposit is also referred to as an impregnation step). The impregnation component may include one or more ZPGM transition metals. The impregnation step converts metal salts (such as nitrate, acetate or chloride) into metal oxides creating a washcoat 104 including at least one catalyst. An overcoat 106 is typically applied after treating washcoat 104, but treating is not required prior to application of overcoat 106 in every embodiment. Preferably, overcoat 106 is applied after washcoat 104. Overcoat 106 may include one or more ZPGM transition metals.

### Washcoat Composition

Washcoat 104 may include at least one ZPGM transition metal catalyst. A ZPGM transition metal catalyst may include one or more transition metals that are completely free of PGM. ZPGM transition metal catalyst may include scandium, titanium, vanadium, chromium, manganese, iron, cobalt, nickel, copper, zinc, yttrium, niobium, molybdenum, silver, tungsten, and gallium. Most suitable ZPGM transition metal for the present disclosure may be manganese. The total amount of manganese may be of about 1% by weight to about 20% by weight of the total catalyst weight, preferred being 4% to 10% by weight.

Additionally, washcoat 104 may include support oxides material referred to as carrier material oxides. Carrier material oxides may include aluminum oxide, doped aluminum oxide, spinel, delafossite, lyonsite, garnet, perovksite, pyrochlore, doped ceria, fluorite, zirconium oxide, doped zirconia, titanium oxide, tin oxide, silicon dioxide, zeolite, and mixtures thereof. Suitable carrier material oxides for the disclosed washcoat 104 may include one or more selected from the group consisting of aluminum oxide (Al₂O₃) or doped aluminum oxide. The doped aluminum oxide in washcoat 104 may include one or more selected from the group consisting of lanthanum, yttrium, lanthanides and mixtures thereof. The amount of doped lanthanum in alumina may vary from 0 percent (i.e., pure aluminum oxide) to 10 percent lanthanum oxide by weight; most suitable 4% to 10% lanthanum oxide by weight. Other mixtures of alumina-lanthanum may also be included in other embodiments of washcoat 104. Carrier material oxide may be present in washcoat 104 in a ratio of about 40 to about 60 by weight. Carrier material oxides are normally inert and stable at high temperatures (>1000° C.) and under a range of reducing and oxidizing conditions.

In the present embodiment, washcoat 104 may include oxygen storage materials (OSM), such as cerium, zirconium, lanthanum, yttrium, lanthanides, actinides, and mixtures thereof. In some embodiments, washcoat 104 may also include other components such as acid or base solutions or various salts or organic compounds that may be added in order to adjust rheology of washcoat 104 slurry and to enhance the adhesion of washcoat 104 to substrate 102. Some examples of compounds that can be used to adjust the rheology may include ammonium hydroxide, aluminum hydroxide, acetic acid, citric acid, tetraethyl ammonium hydroxide, other tetralkyl ammonium salts, ammonium acetate, ammonium citrate, glycerol, commercial polymers such as polyethylene glycol, polyvinyl alcohol and other suitable compounds. Preferred solution to enhance binding of washcoat 104 to substrate 102 may be tetraethyl ammonium hydroxide. Washcoat 104 loading can be varied from 60 g/L to 200 g/L. In other embodiments, other components known to one of ordinary skill in the art may be included in washcoat 104.

### Overcoat Composition

Overcoat 106 may include ZPGM transition metal catalysts that may include one or more transition metals, and least one rare earth metal, or mixture thereof that are completely free of PGM. The transition metals may be a single transition metal, or a mixture of transition metals which may include chromium, manganese, iron, cobalt, nickel, copper, niobium, molybdenum, and tungsten. Most suitable ZPGM transition metal may be copper. Preferred rare earth metal may be cerium. The total amount of copper metal included in overcoat 106 may be of about 5% by weight to about 30% by weight of the total catalyst weight, most suitable of about 10% to 16% by weight. Furthermore, the total amount of cerium metal included in overcoat 106 may be of about 5% by weight to about 50% by weight of the total catalyst weight, most suitable of about 10% to 20% by weight. In embodiments, different suitable copper salts as well as different suitable cerium salts such as nitrate, acetate or chloride may be used as ZPGM precursors. In other embodiments, additional ZPGM transition metals may be included in overcoat 106 composition.

According to the present embodiment, overcoat 106 may include carrier material oxides. Carrier material oxides may include aluminum oxide, doped aluminum oxide, spinel, delafossite, lyonsite, garnet, perovksite, pyrochlore, doped ceria, fluorite, zirconium oxide, doped zirconia, titanium oxide, tin oxide, silicon dioxide, zeolite, and mixtures thereof. Suitable carrier material oxides for the disclosed overcoat 106 may include one or more selected from the group consisting of aluminum oxide (Al₂O₃) or doped aluminum oxide. The doped aluminum oxide in overcoat 106 may include one or more selected from the group consisting of lanthanum, yttrium, lanthanides and mixtures thereof. The amount of doped lanthanum in alumina may vary from 0 percent (i.e., pure aluminum oxide) to 10 percent lanthanum oxide by weight; most suitable 4% to 10% lanthanum oxide by weight. Other mixtures of alumina-lanthanum may also be included in other embodiments of overcoat 106. Carrier material oxide may be present in overcoat 106 in a ratio of about 40 to about 60 by weight.

Additionally, according to one embodiment, overcoat 106 may also include OSM. The amount of OSM may be of about 10 to about 60 weight percent, most suitable of about 20 to about 40 weight percent. The weight percent of OSM is on the basis of the oxides. The OSM may include at least one oxide selected from the group consisting of cerium, zirconium, lanthanum, yttrium, lanthanides, actinides, and mixtures thereof. OSM in the present overcoat 106 may be a mixture of ceria and zirconia; more suitable a mixture of (1) ceria, zirconia, and lanthanum or (2) ceria, zirconia, neodymium, and praseodymium. In addition to oxygen storage property, OSM may improve the adhesion of overcoat 106 to washcoat 104. Overcoat 106 loading may be varied from 40 g/L to 200 g/L. In other embodiments, other components known to one of ordinary skill in the art may be included in overcoat 106.

In an embodiment, washcoat 104 may be formed on substrate 102 by suspending the oxide solids in water to form an aqueous slurry and depositing the aqueous slurry on substrate 102 as washcoat 104. Subsequently, in order to form ZPGM TWC catalyst system 100, overcoat 106 may be deposited on washcoat 104.

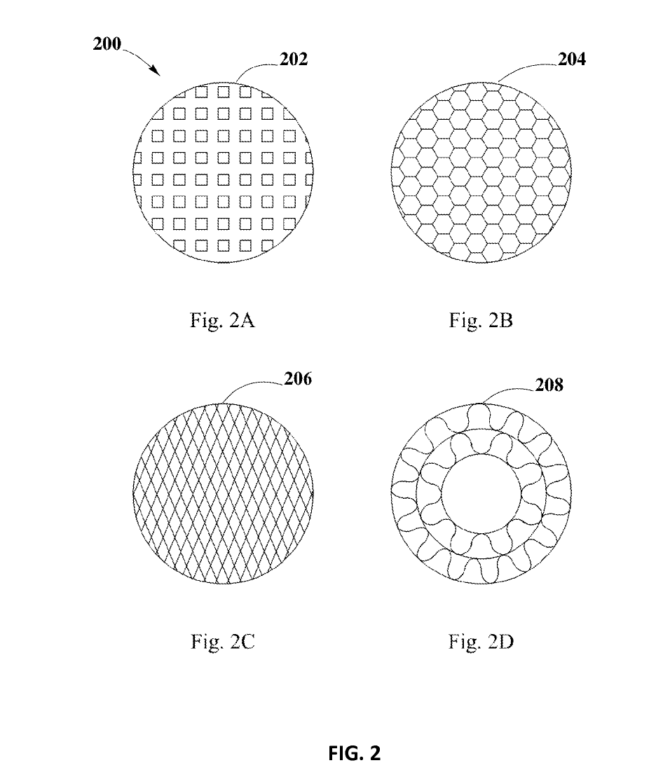

FIG. 2 illustrates examples of substrate structures 200, according to various embodiments. FIG. 2 A shows substrate 102 with square pattern 202. FIG. 2 B illustrates a substrate 102 with honeycomb structure 204. FIG. 2 C shows a substrate 102 with diamond shaped pattern 206 and FIG. 2 D shows sinusoidal wave 208 patterned substrate 102. Substrates 102 may display other patterns suitable to be used as oxidation or three way catalyst converters. According to an embodiment the catalyst converter may have a plurality of flow channels extending through its length in similar arrangements to the ones disclosed in FIGS. 2A, 2B, 2C and 2D. In some embodiments substrate 102 may be shaped in form of a filter, for example a wall flow-through filter, having suitable porosity. Suitable materials for substrate 102 may include refractive materials, ceramic materials, metallic alloys, foams, microporous materials, zeolites, cordierites, mullite, or combinations. Specific compositions, sizes, volumes and cell densities of substrate 102 may vary according to the specifics of each application.

### EXAMPLES

In example #1 a ZPGM TWC catalyst system 100, including a substrate 102, a washcoat 104 and an overcoat 106, is created. The substrate 102 used is cordierite. The washcoat 104 may include alumina, at least one OSM, and at least one transition metal such as manganese. The OSM includes a mixture of cerium, zirconium, neodymium, and praseodymium. This OSM may be present in the washcoat 104 in a ratio of about 40 to about 60. The manganese in washcoat 104 may be present in about 1% to about 20%, preferably about 4% to about 10% by weight. Overcoat 106 may include copper oxide, ceria, and alumina. Overcoat 106 includes at least one OSM. OSM may be present in overcoat 106 in a ratio of about 40 to about 60. The copper and cerium in overcoat 106 may be present in about 5% to about 50%, preferably about 10% to 16% by weight of Cu and 12% to 20% by weight of Ce. To produce the ZPGM TWC catalyst system 100 of example #1, ZPGM transition metals such as Mn and a carrier material oxide may be milled together. The milled ZPGM catalyst and carrier material oxide may be deposited on substrate 102 in the form of washcoat 104. Then, the washcoated substrate 102 may be heat treated. Overcoat 106 may be prepared in a similar manner. Following the washcoat 104 and overcoat 106 steps, the heat treating may be done at a temperature between 300° C. and 700° C., preferably about 550° C. The heat treating may last from about 2 to about 6 hours, preferably about 4 hours for washcoat 104 and overcoat 106.

ZPGM catalyst of example #1 is an embodiment of ZPGM TWC catalyst system 100 that includes the following washcoat 104 and overcoat 106 compositions. The total loading of washcoat 104 is 120 g/L and total loading of overcoat 106 is 120 g/L.

| | | | CARRIER |
|---|---|---|---|
| LAYER | ZPGM | OSM | MATERIAL OXIDES |
| WASHCOAT | Mn | Ce—Zr—Nd—Pr | Lanthanum doped alumina |
| OVERCOAT | Cu—Ce | Ce—Zr—Nd—Pr | Lanthanum doped Alumina |

ZPGM TWC catalyst system 100 of example #1 is tested in the different simulated conditions for TWC applications as follows.

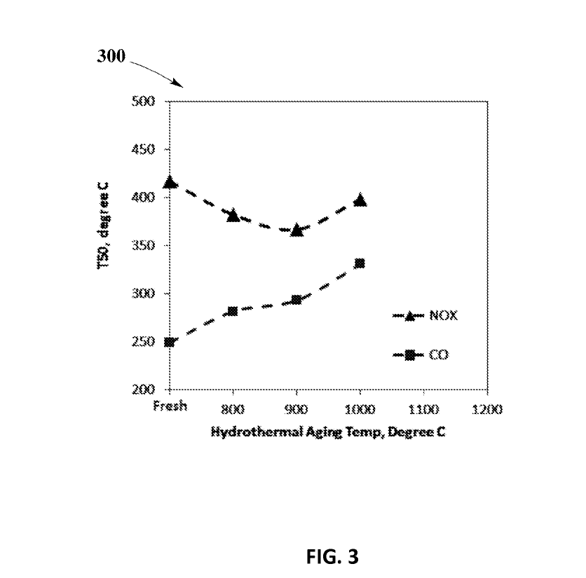

FIG. 3 shows sensitivity of ZPGM catalyst to aging temperature 300. ZPGM catalyst of example #1 is hydrothermally aged at different temperatures with 10% steam. The aging temperatures are varied to 800° C., 900° C., and 1000° C. and the duration of aging is between 4 hours to 6 hours, preferably 4 hours. FIG. 3 shows T50 of NOX and T50 of CO for ZPGM catalyst of example #1 for fresh and after hydrothermal aging at temperature of 800° C. to 1000° C. T50 of NOx and T50 values of CO are collected from steady state light-off test where propylene (C3H6) is the feed hydrocarbon under rich condition with R-value=1.224. Sensitivity of ZPGM catalyst to aging temperature 300 shows T50 of NOx of fresh ZPGM catalyst decreased after hydrothermal aging at 800° C. A similar trend was observed for sample aged at 900° C., showing improvement of ZPGM catalyst for NOx conversion after aging. T50 of NOx shows small increase after aging at 1000° C.; however, the aged sample is as active as a fresh sample. T50 of CO shows different behavior. The T50 of CO for fresh sample augmented by increasing the aging temperature in this test.

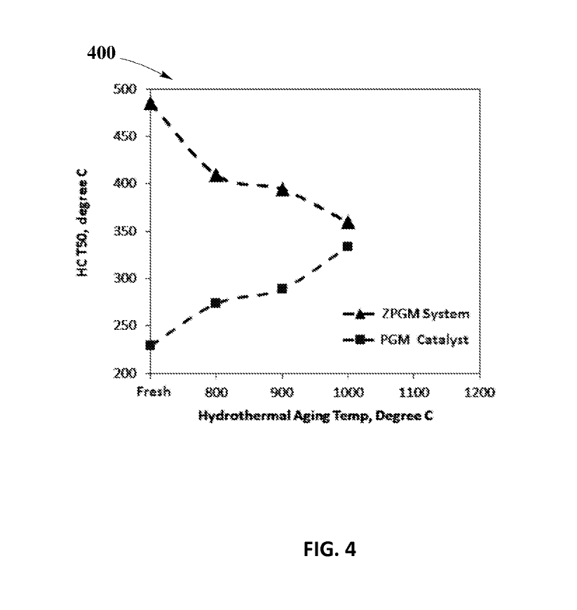

FIG. 4 shows comparison 400 between the ZPGM catalyst system from example #1 and a standard PGM catalyst, used as reference catalyst. The PGM reference catalyst includes Rh (about 6 g/ft³) and Pd (about 6 g/ft³). Sensitivity of ZPGM and PGM catalyst to aging temperature is tested. All samples are hydrothermally aged at different temperatures with 10% steam. The aging temperatures are 800° C., 900° C., and 1000° C. The duration of aging is between 4 hours to 6 hours, preferably 4 hours. T50 of HC values are collected from steady state light-off test where propylene (C₃H₆) is the feed hydrocarbon under rich condition with R-value=1.224. As a result, the HC T50 of fresh ZPGM system of example #1 decreased substantially after aging. The improvement of HC conversion in ZPGM catalyst system of example #1 continued by increasing the aging temperature to 1000° C., where the HC T50 of ZPGM catalyst approximately meets the HC T50 of reference PGM catalyst at around 350° C.

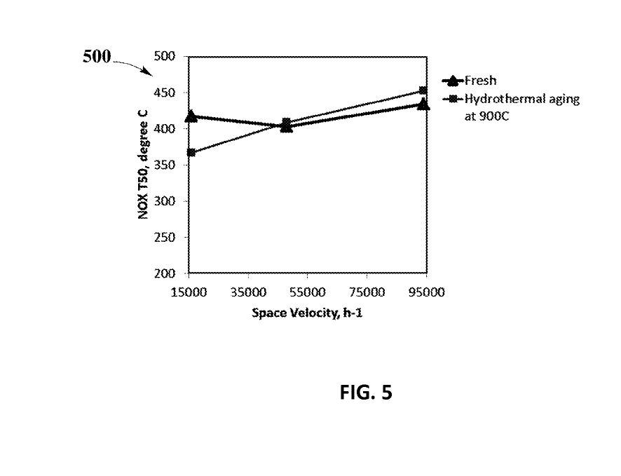

In Example #2 The sensitivity of ZPGM catalyst to space velocity 500 is tested. FIG. 5 shows T50 of NOX for ZPGM catalyst of example #1 for fresh and aged samples against different space velocities, ranging from 15,000 h−1 to 95,000 h−1. ZPGM catalyst of example #1 is hydrothermally aged at 900° C. with 10% steam. The duration of aging is between 4 hours to 6 hours, preferably 4 hours. Values of T50 of NOx are collected from steady state light-off test where propylene (C₃H₆) is the feed hydrocarbon under rich condition with R-value=1.224. Test results are illustrated in FIG. 5, where no significant dependency of NOX T50 to space velocity is shown for fresh samples. However, T50 of NOX increased 85° C. by raising the space velocity from 15,000 h−1 to 95,000 h−1 for aged samples.

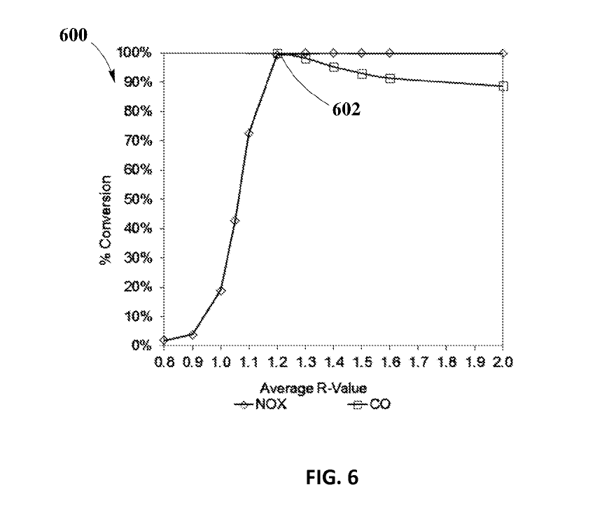

In Example #3 A TWC sweep test was performed. A ZPGM catalyst system of example #1 is tested under variation of Air/Fuel ratios (representative as R-values) from rich condition to lean condition. FIG. 6 shows sweep test results under steady state condition 600 for ZPGM catalyst systems of example #1. Sweep test results under steady state condition 600 are performed at constant temperature of about 450° C., which is the typical temperature for under floor TWC catalyst. The feed stream for this test is typical TWC gas composition, containing 10% CO2, 10% H2O, 800 ppm CO, 200 ppm H2, 400 ppm C3H6, 100 ppm C3H8, 1000 ppm NOX, and variable O2 to adjust A/F ratio. This test is performed with 11 points sweep by variation of O2 amount to change R value and sweeping from rich condition (R=2.0) to lean condition (R=0.8). FIG. 6 also shows NO and CO conversion results of sweep test for ZPGM catalyst of example#1 after hydrothermal aging at 900° C. with a space velocity of 40,000 h−1. NO/CO cross over 602 point is measured at R-value=1.22.

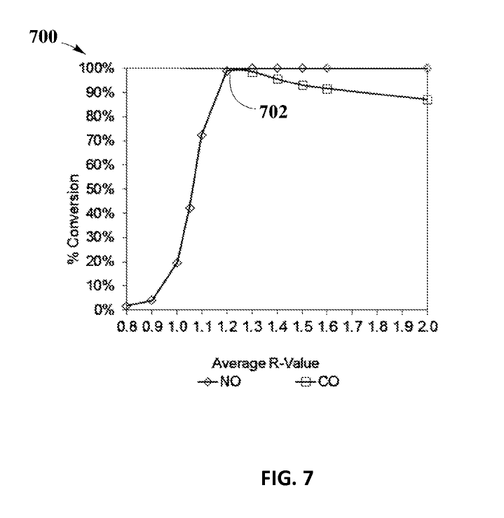

FIG. 7 shows sweep test result under oscillating condition 700 for ZPGM catalyst systems of example #1. Sweep test result under oscillating condition 700 is performed at constant temperature of 450° C. and an Air/Fuel span=±0.2. The feed stream for this test is typical TWC gas composition, containing 10% CO2, 10% H2O, 800 ppm CO, 200 ppm H2, 400 ppm C3H6, 100 ppm C3H8, 1000 ppm NOX, and variable O2 to adjust A/F ratio. This test is performed with 11 points sweep by variation of O2 amount to change R value, sweeping from rich condition (R=2.0) to lean condition (R=0.8). FIG. 7 shows NO and CO conversion results of sweep test for ZPGM catalyst system of example#1 after hydrothermal aging at 900° C. with a space velocity of 40,000 h−1. NO/CO cross over 702 point is measured at R-value=1.24. This data shows that NO/CO cross over 702 point is not sensitive to oscillating condition.

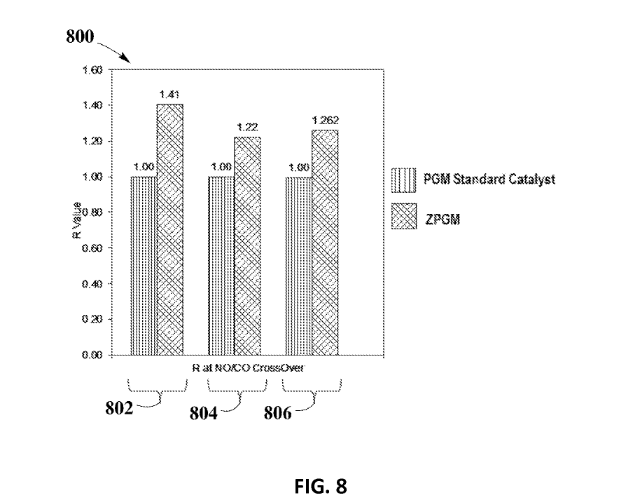

FIG. 8 shows comparisons of R-values 800 for sweep test results under steady state condition 600 for ZPGM catalyst systems of example #1 and a standard PGM reference catalyst system. The PGM reference catalyst system includes Rh (about 6 g/ft̂3) and Pd (about 6 g/ft̂3). R-values are at NO/CO cross over 602 under steady state condition and space velocity of this test is 40,000 h−1. In FIG. 8, Bars one 802 shows comparison of ZPGM and reference PGM catalyst systems in a fresh state, bars two 804 shows comparison of ZPGM catalyst system and reference PGM catalyst system after hydrothermal aging at 900° C., and bars three 806 shows comparison of ZPGM catalyst system and reference PGM catalyst system after hydrothermal aging at 1000° C. Comparisons of R-values 800 shows that aging may help ZPGM catalyst to decrease the gap between cross point R-values of ZPGM catalyst and reference PGM catalyst.

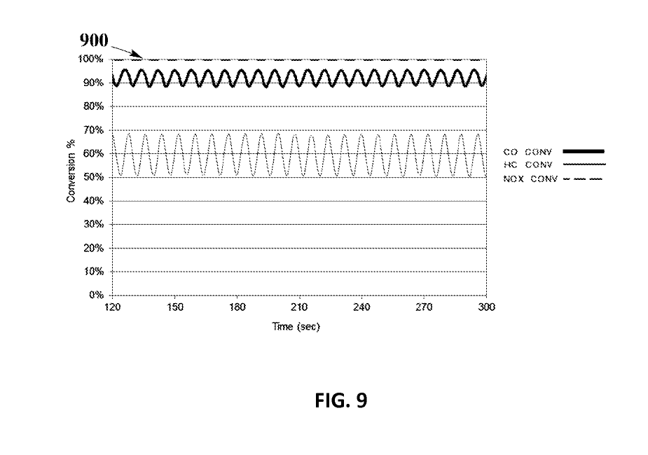

FIG. 9 shows oscillating isothermal test 900. FIG. 9 shows results for oscillating isothermal test 900 at 550° C. for ZPGM TWC catalyst system 100 from example #1. Oscillating isothermal test 900 is performed at average R-value=1.30 with space velocity of 40,000 h−1. The ratio of propylene (C₃H₆) to propane (C₃H₃) in feed stream is 2 and the ratio of carbon monoxide (CO) to hydrogen (H₂) is 3. In this test, the air to fuel ratio Span=±0.4 and low frequency=0.125 Hz applied. The ZPGM catalyst system from example #1 is hydrothermally aged at 900° C. with 10% steam. The duration of aging is between 4 hours to 6 hours, preferably 4 hours. Oscillating isothermal test 900 shows that ZPGM TWC catalyst system 100 of example #1 may have an average CO conversion of 92%, average NOx conversion at 100%, and average HC conversion at 60% at this condition.

Example #4 A ZPGM TWC catalyst system 100 including a ZPGM transition metal catalyst may have a metallic substrate 102, a washcoat 104 and an overcoat 106 is prepared. The substrate 102 is metallic, cylindrical and may have different sizes. In this example, metallic substrate 102 has a diameter of 40 mm, a length of 60 mm, a cell density of 300 cpsi and a volume of 0.0754 L. The washcoat 104 may include alumina, at least one OSM, and at least one transition metal such as manganese. The OSM includes a mixture of cerium, zirconium, neodymium, and praseodymium. This OSM may be present in the washcoat 104 in a ratio of about 60 to about 40. The manganese in washcoat 104 may be present in about 1% to about 20%, preferably about 4% to about 10% by weight. Overcoat 106 may include copper oxide, ceria, and alumina. Overcoat 106 includes at least one OSM. OSM may be present in overcoat 106 in a ratio of about 60 to about 40. The copper and cerium in overcoat 106 may be present in about 5% to about 50%, preferably about 10% to 16% by weight of Cu and 12% to 20% by weight of Ce. To produce the ZPGM TWC catalyst system 100 of example #4, ZPGM transition metals such as Mn and a carrier material oxide may be milled together. The milled ZPGM catalyst and carrier material oxide may be deposited on substrate 102 in the form of washcoat 104. Then, the washcoated substrate 102 may be heat treated. Overcoat 106 may be prepared in a similar manner. Following the washcoat 104 and overcoat 106 steps, the heat treating may be done at a temperature between 300° C. and 700° C., preferably about 550° C. The heat treating may last from about 2 to about 6 hours, preferably about 4 hours for washcoat 104 and overcoat 106.

What is claimed:

1. A zero platinum group metal (ZPGM) catalyst system, comprising:
a substrate;
an overcoat suitable for deposition on the substrate, comprising at least one overcoat oxide solid selected from the group consisting of at least one first carrier material oxide, and at least one first ZPGM catalyst; and
a washcoat suitable for deposition on the substrate, comprising at least one oxide solid selected from the group consisting of at least one second carrier material oxide, and at least one second ZPGM catalyst;
wherein at least the first ZPGM catalyst is selected from the group consisting of copper, cerium, manganese, and combinations thereof, and wherein the substrate at least partially comprises one selected from the group consisting of a refractive material, ceramic material, metallic alloy, foam, microporous material, zeolite, cordierite, or a combination thereof; and
wherein the at least one first carrier material oxide is selected form the group consisting of aluminum oxide (Al₂O₃) or doped aluminum oxide.

2. The ZPGM catalyst system of claim 1, wherein the washcoat further comprises at least one oxygen storage material.

3. The ZPGM catalyst system of claim 2, wherein the oxygen storage material is selected from the group consisting of cerium, zirconium, lanthanum, yttrium, lanthanides, actinides, neodymium, praseodymium, and mixtures thereof

4. The ZPGM catalyst system of claim 1, wherein the overcoat further comprises at least one oxygen storage material.

5. The ZPGM catalyst system of claim 4, wherein the oxygen storage material is selected from the group consisting of cerium, zirconium, lanthanum, yttrium, lanthanides, actinides, and mixtures thereof.

6. The ZPGM catalyst of claim 1, wherein the doped aluminum oxide is selected from the group consisting of lanthanum, yttrium, lanthanide, and mixtures thereof.

7. The ZPGM catalyst of claim 1, wherein the at least one second carrier material oxide is selected form the group consisting of aluminum oxide (Al₂O₃) and doped aluminum oxide.

8. The ZPGM catalyst of claim 8, wherein the doped aluminum oxide is selected from the group consisting of lanthanum, yttrium, lanthanide, and mixtures thereof.

9. The ZPGM catalyst of claim 1, wherein the overcoat further comprises at least one selected from the group consisting of copper oxide, cerium oxide, and alumina.

10. The ZPGM catalyst of claim 9, wherein the copper oxide comprises about 10% to 16% by weight of the overcoat.

11. The ZPGM catalyst of claim 9, wherein the cerium oxide comprises about 12% to 20% by weight of the overcoat.

12. The ZPGM catalyst of claim 4, wherein the oxygen storage material comprises about 60% of the overcoat by weight.

13. The ZPGM catalyst of claim 1, wherein the substrate comprises cordierite.

14. The ZPGM catalyst of claim 1, wherein the at least one second ZPGM catalyst comprises manganese.

15. The ZPGM catalyst of claim 1, wherein the T50 of NOx is about 400° C. at a space velocity of about 15000 to about 95000.

16. A zero platinum group metal (ZPGM) catalyst system, comprising:
a substrate;
an overcoat suitable for deposition on the substrate, comprising at least one overcoat oxide solid selected from the group consisting at least one of a first carrier material oxide, and at least one first ZPGM catalyst; and
a washcoat suitable for deposition on the substrate, comprising at least one oxide solid selected from the group consisting of at least one second carrier material oxide, and at least one second ZPGM catalyst comprising manganese;
wherein the at least one first ZPGM catalyst is selected from the group consisting of copper, cerium, and combinations thereof, and
wherein the at least one first ZPGM catalyst is hydrothermally aged.

17. The ZPGM catalyst of claim 16, wherein the hydrothermal aging further comprises about 10% steam.

18. The ZPGM catalyst of claim 16, wherein the hydrothermal aging further comprises a temperature range of about 800° C. to about 1000° C.

19. The ZPGM catalyst of claim 16, wherein the hydrothermal aging improves NOx conversion.

20. The ZPGM catalyst of claim 16, wherein the hydrothermal aging improves hydrocarbon conversion.

21. The ZPGM catalyst of claim 16, wherein the hydrothermal aging improves NOx conversion.

22. The ZPGM catalyst of claim 16, wherein the T50 of NOx is about 350° C. at a space velocity of about 15000.

23. The ZPGM catalyst of claim 16, wherein the T50 of NOx is about 450° C. at a space velocity of about 95000.

24. The ZPGM catalyst of claim 16, wherein the R value at the NO/CO crossover is about 1.22.

25. The ZPGM catalyst of claim 16, wherein NO and CO conversion is higher under isothermal oscillating conditions.
